(19) United States
(12) Patent Application Publication
(10) Pub. No.: US 2014/0045558 A1
(43) Pub. Date: Feb. 13, 2014

(54) Cellular Phone Including Light-Emitting Device in Battery Cover

(71) Applicant: Jin Hae Kim, Seoul (KR)

(72) Inventor: Jin Hae Kim, Seoul (KR)

(73) Assignee: CHEMRICH CO., LTD., Gyeonggi-do (KR)

(21) Appl. No.: 14/113,585

(22) PCT Filed: Apr. 12, 2012
(86) PCT No.: PCT/KR2012/002771

§ 371 Date: Oct. 24, 2013

(30) Foreign Application Priority Data
Apr. 26, 2011 (KR) 10-2011-0039088

(51) Int. Cl. H04M 1/02

(52) U.S. Cl. CPC H04M 1/0262
USPC 455/575.1

(57) ABSTRACT

Provided is a cellular phone having a light-emitting device in a battery cover the cellular phone. The cellular phone includes a main body that includes a battery-receiving portion for installing a battery, a battery cover that covers the battery-receiving portion and is removably coupled to the main body, a power-generating antenna in the form of a coil that is provided in the battery cover and converts electromagnetic waves emitted from the cellular phone into electricity, a light-emitting diode that is electrically connected to the power-generating antenna to generate light, a light-transfer sheet that transfers the light generated in the light-emitting diode, and a light-emitting object that is formed on a surface of the light-transfer sheet and emits the light generated from the light-emitting diode to the outside of the battery cover.

### TECHNICAL FIELD

The present invention relates to a cellular phone.

### BACKGROUND ART

Portable mobile communication apparatuses, such as cellular phones, Personal Digital Assistants (PDAs), and so forth, which have been widely used with the rapid development of communication technologies, are taking root as necessities to the modern people, because users may talk on the communication apparatuses regardless of user location while carrying the communication apparatuses.

Cellular phones, in line with dramatic advances in recent technologies, are now evolving into highly-priced devices having added thereto various functions satisfying a variety of consumer needs, such as camera functions, MP3 player functions, and Digital Multimedia Broadcasting (DMB) functions, as well as a simple function of initiating and receiving calls. These days, cellular phones called “smartphones” are popularly used.

Meanwhile, cellular phone manufacturers are making efforts to satisfy various needs of users by developing products that have aesthetically pleasing exterior designs and the various functions described above. That is, between cellular phones having identical functions, a consumer may select the cellular phone that has the most pleasing design. Thus, a design aspect, as well as a functional aspect, becomes a critical factor for product selection.

The design aspect is usually implemented in a case that forms an exterior of a cellular phone by using limited methods such as by drawing or printing a decorative figure like a picture on the surface of a conventional cellular phone case or coupling an auxiliary case made of a fiber or leather material to the cellular phone case. However, such methods now do not satisfy various tastes of users.

In particular, batteries are mounted on cellular phones as energy sources for driving the cellular phones. To replace, remove or mount the battery, a battery cover is generally installed on a rear portion of the cellular phone. However, the battery cover merely functions for removing or mounting the battery without improving the aesthetic aspect of the cellular phone.

### DETAILED DESCRIPTION OF THE INVENTION

### Technical Problem

The present invention provides a cellular phone that includes a wireless light-emitting device, which does not need a separate power source, in a battery cover of the cellular phone, thus improving the aesthetic aspect of the cellular phone.

### Technical Solution

According to an aspect of the present invention, there is provided a cellular phone having a light-emitting device in a battery cover of the cellular phone, the cellular phone including a main body that forms an outer form of the cellular phone and that includes a battery-receiving portion for installing a battery in a rear portion of the main body, a battery cover that covers the battery-receiving portion and is removably coupled to the main body, a power-generating antenna in the form of a coil that is provided in the battery cover and converts electromagnetic waves emitted from the cellular phone into electricity based on electromagnetic induction, a light-emitting diode that is electrically connected to the power-generating antenna to generate light, a light-transfer sheet that transfers the light generated in the light-emitting diode by using total reflection, and a light-emitting object that is formed on a surface of the light-transfer sheet and emits the light generated from the light-emitting diode to the outside of the battery cover by reflecting the light generated from the light-emitting diode.

### Advantageous Effects

A cellular phone according to the present invention drives a light-emitting device installed in a battery cover by using, as a power source, electromagnetic waves emitted from the cellular phone when the cellular phone is online or an NFC module is activated. Based on the manner above, the light-emitting device is powered by the electromagnetic waves emitted from the cellular phone, without separately supplying power to the battery cover separated from a main body, thereby improving an aesthetic function of the cellular phone without consuming additional power from the battery in order to operate the light-emitting device.

### DESCRIPTION OF THE DRAWINGS

FIG. 1 is a schematic diagram showing a cellular phone according to an exemplary embodiment of the present invention;

FIG. 2 is a schematic diagram showing an internal structure of a battery cover of a cellular phone shown in FIG. 1;

FIG. 3 is a schematic cross-sectional diagram cut along a line III-III of FIG. 2;

FIG. 4 is a schematic floor plan showing a light-emitting device shown in FIG. 3; and

FIG. 5 is a schematic diagram showing a battery cover of a cellular phone according to another exemplary embodiment of the present invention.

### BEST MODE

Hereinafter, exemplary embodiments of the present invention will be described in detail with reference to the accompanying drawings.

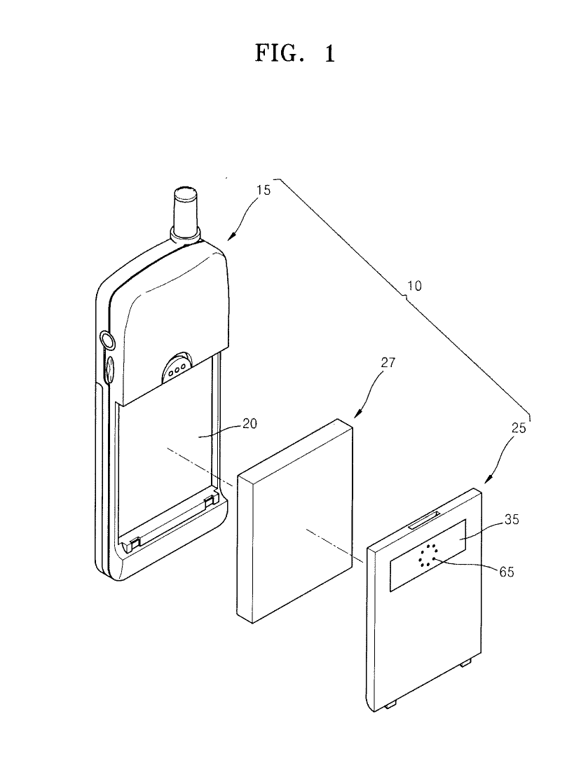

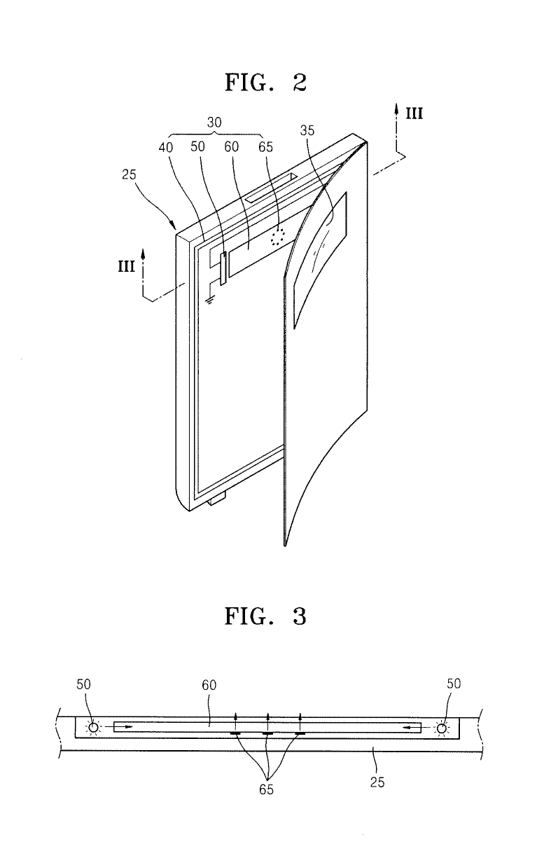

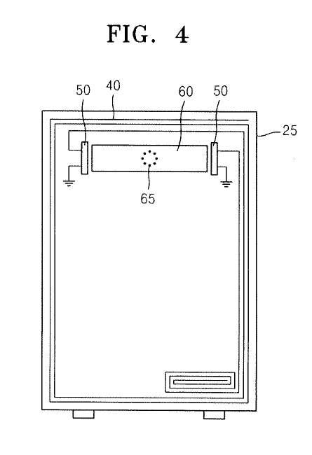

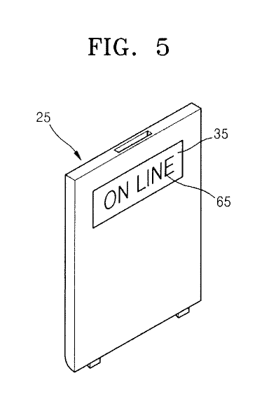

FIG. 1 is a schematic diagram showing a cellular phone according to an exemplary embodiment of the present invention, FIG. 2 is a schematic diagram showing an internal structure of a battery cover of a cellular phone shown in FIG. 1, FIG. 3 is a schematic cross-sectional diagram cut along a line III-III of FIG. 2, FIG. 4 is a schematic floor plan showing a light-emitting device shown in FIG. 3, and FIG. 5 is a schematic diagram showing a battery cover of a cellular phone according to another exemplary embodiment of the present invention.

A cellular phone 10 having a light-emitting device in a battery cover according to an exemplary embodiment of the present invention wireless communicates with a terminal via a base station. The cellular phone 10 may be applied to communication apparatuses such as a general cellular phone, a smart phone, Personal Digital Assistants (PDAs), and so forth which have wireless phone functions.

The cellular phone 10 may include a main body 15 and a battery cover 25.

The main body 15 may have a printed circuit board (not shown) for communication, a display, a keypad, or a touch screen installed therein. The main body 15 forms an outer form of the cellular phone 10 and includes a battery-receiving portion 20 in a rear portion thereof, in which a battery 27 is installed.

The battery cover 25 covers the battery-receiving portion 20 and is removably coupled to the main body 15.

The battery cover 25 may include a light-emitting device 30.

The light-emitting device 30 may include a power-generating antenna 40, a light-emitting diode 50, a light-transfer sheet 60, and a light-emitting object 65.

Referring to FIG. 1, a display 35 that is transparent is formed on an outer side of the battery cover 25. The display 35 passes light therethrough to allow light emitted by the light-emitting object 65 to be seen from the outer side of the battery cover 25. The display 35 may be formed of a transparent film or a colored film, which passes light therethrough. A core element of the present invention, the light-emitting device 30, is provided under the display 35.

The power-generating antenna 40 is in the form of a coil that converts electromagnetic waves, which are emitted when the cellular phone is online, or emitted when receiving a call requesting signal in the cellular phone 10, into electricity based on electromagnetic induction. Generally, the electromagnetic waves emitted when the cellular phone is online or when receiving a call requesting signal in the cellular phone 10 have a particular frequency and are much stronger than those emitted when the cellular phone 10 is in a standby state. The electromagnetic waves, emitted by the cellular phone 10 when the cellular phone is online or when receiving a call requesting signal in the cellular phone 10, are three-dimensional (3D) waves and have energy. The power-generating antenna 40, which is in the form of a coil, generates electricity based on electromagnetic induction therein because magnetic force lines of the electromagnetic waves emitted from the cellular phone 10 repetitively change at predetermined intervals. The current generated in the power-generating antenna 40 is used as a power source for driving the light-emitting diode 50. Since the current generated in the power-generating antenna 40 is an Alternating Current (AC), the power-generating antenna 40 is electrically connected to the light-emitting diode 50 through a separately provided rectifying circuit, thus supplying power to the light-emitting diode 50. If the cellular phone 10 has a mobile commerce function by an NFC module, electromagnetic waves exchanged between the cellular phone 10 and a mobile commerce terminal during communication therebetween are converted into electricity by the power generating antenna 40 based on electromagnetic induction.

The light-emitting diode 50 is electrically connected to the power-generating antenna 40. The light-emitting diode 50 generates light with supplied power. As the light-emitting diode 50, a plurality of light-emitting diodes may be provided.

The light-transfer sheet 60 is a member for transferring the light generated in the light-emitting diode 50 based on total reflection. The light-transfer sheet 60 takes the form of a thin plate.

Due to a difference in density between the air and the light-transfer sheet 60, the light incident to the light-transfer sheet 60 is totally reflected at an interface between the air and the light-transfer sheet 60, thus propagating along the inside of the light-transfer sheet 60. The light-transfer sheet 60 may be formed of a transparent material or a colored material. For example, the light-transfer sheet 60 may be made of one of poly acryl, poly carbonate (PC), poly ethylene (PET), a poly urethane (PU), a polymethacryl acid methyl ester (PMMA), a polyvinyl chloride (PVC), and silicon. In the current embodiment, a sheet of poly acryl resin may be used as the light-transfer sheet 60.

The light-emitting object 65 is formed on a surface of the light-transfer sheet 60. More specifically, the light-emitting object 65 is formed on a bottom surface of the light-transfer sheet 60. That is, the light-emitting object 65 is disposed on a surface of the light-transfer sheet 60 opposite facing the display 35, with the light-transfer sheet 60 between the light-emitting object 65 and the display 35. The light-emitting object 65 reflects the light generated from the light-emitting diode 50 toward the display 35. That is, the light-emitting object 65 rapidly changes the direction of the light propagating along the inside of the light-transfer sheet 60 to reflect the light at an angle equal to or larger than an angle at which total reflection may occur, thus emitting the light to the outside of the light-transfer sheet 60. As a result, a portion of the light propagating along the light-transfer sheet 60 is emitted to the outside of the battery cover 25 by means of the light-emitting object 65. The light-emitting object 65 may include a dot pattern, a line pattern, or a plane pattern. In the current embodiment shown in FIG. 1, the light-emitting object 65 forms a dot pattern. The light-emitting object 65 may be formed by being printed in ink on a surface of the light-transfer sheet 60. The light-emitting object 65 may be printed using a well-known printing method such as an offset printing method, a screen printing method, or a pad printing method. In another embodiment shown in FIG. 5, the light-emitting object 65 may also form characters in a line pattern.

A plurality of light-emitting objects 65 may be provided to have different colors. By arranging the light-emitting objects 65 variously, an aesthetic value of the cellular phone 10 may be improved.

The light-emitting object 65 may include one selected from modified poly acryl, modified poly urethane (PU), modified polyester (PE), and silicon dioxide (SiO₂). The light-emitting object 65 may be made in the form of ink or paste depending on viscosities thereof and may be attached to the light-transfer sheet 60. The light-emitting object 65, after being printed, may be dried to have sufficient solidity by using an Infrared (IR) drying method, a box oven method, or an Ultraviolet (UV) drying method.

The light-emitting objects 65 may include fluorescent materials or dispersing agents. If the light-emitting object 65 includes fluorescent materials or dispersing agents, the light-emitting object 65 may be emit light having a color other than white. FIG. 5 shows another embodiment of the present invention in which characters in different colors “online” may be used as the light-emitting object 65. The fluorescent materials included in the light-emitting object 65 may include a sulfide of zinc, strontium, and barium to easily implement colors, but may also include other types of materials. The dispersing agents may use well-known materials and thus will not be described in detail.

In a portion near the light-emitting object 65, a reflective plate may be further provided in a position facing the light-transfer sheet 60, with the light-emitting object 65 between the reflective plate and the light-transfer sheet 60. The reflective plate (not shown) reflects light, which is reflected from the light-emitting object 65 in the opposite direction to the display 35, back to the display 35, thus increasing the brightness of the light-emitting object 65 recognized from the outside. The light reflected from the light-emitting object 65 may be seen from the outside through the display 35. If the light-emitting object 65 is configured to reflect a predetermined amount of light without a predetermined pattern formed on the light-emitting objects 65, a predetermined character or design may be formed on the display 35 to selectively pass therethrough the light projected from the light-emitting object 65. A decorative film having a separate character or design printed thereon may be further provided under the display 35.

While it is described in the current embodiment that the light-emitting object 65 is formed by printing, the light-emitting object 65 may also be formed on a surface of the light-transfer sheet 60 by using V-cut or laser processing with Computerized Numerical Control (CNC). The light-emitting object 65 may be formed integrally with the light-transfer sheet 60 by using injection-molding.

Hereinafter, the operation of the cellular phone 10 according to the embodiments of the present invention will be described in detail.

The cellular phone 10, while in a standby state, continuously communicates with a base station for positioning and terminal identification. In the standby state, the strength of the electromagnetic waves emitted to the outside by the cellular phone 10 is not large enough to induce electromagnetic induction in the power-generating antenna 40. Thus, when the cellular phone 10 is in the standby state, the light-emitting device 30 provided in the battery cover 25 does not receive power, and thus does not operate.

A description will now be made of a case where a call request signal is transmitted from the base station to the cellular phone 10.

When the call request signal is transmitted from the base station to the cellular phone 10, a call request sensing circuit installed in the cellular phone 10 senses the call request signal and generates a sound signal or a vibration signal informing a user of the incoming call. The user then presses a call button to initiate a call. If the sound signal or the vibration signal informing the user of the incoming call is generated or the call is initiated, electromagnetic waves much stronger than those emitted when the cellular phone 10 is in the standby state are emitted to the outside of the cellular phone 10. The electromagnetic waves generated during the transmission of a call request signal and the subsequent initiation of a call change the shape of magnetic force lines around the power-generating antenna 40 of the light-emitting device 30. Based on electromagnetic induction caused by the change in the magnetic force and the magnetic force lines, current is generated in the power-generating antenna 40. If the cellular phone 10 has a mobile commerce function by the NFC module, a mobile commerce terminal and the cellular phone 10 communicate with one another at a particular frequency when the NFC module is activated. Also in this case, the power-generating antenna 40 converts electromagnetic waves exchanged between the cellular phone 10 and the mobile commerce terminal into electricity based on electromagnetic induction.

The current generated in the power-generating antenna 40 is AC, and thus a separate rectifying circuit for rectification and amplification may be provided. The current generated in the power-generating antenna 40 is provided to the light-emitting diode 50, and the light-emitting diode 50 emits light with the provided current. The light emitted by the light-emitting diode 50 is incident to a surface of the light-transfer sheet 60. Due to a difference in density between the air and the light-transfer sheet 60, the light incident to the light-transfer sheet 60 is not reflected to the outside of a top surface or a bottom surface of the light-transfer sheet 60, since there is no total reflection, and the light incident to the light-transfer sheet 60 propagates along the inside of the light-transfer sheet 60. A portion of the light propagating along the inside of the light-transfer sheet 60 contacts the light-emitting object 65. The light-emitting object 65 is in the form of a dot that protrudes from a surface of the light-transfer sheet 60, such that total reflection occurs between the surface of the light-emitting object 65 and the air. The direction of the light totally reflected at the interface between the light-emitting object 65 and the air rapidly changes, such that an incident angle at which the light may move outside the light-transfer sheet 60 is formed. As a result, the light contacting the light-emitting object 65 is oriented toward the display 35 as shown in FIG. 3. The display 35 is configured to pass the light therethrough, and thus the light reflected from the light-emitting object 65 may be recognized from the outer side of the battery cover 25.

In this way, in the battery cover 25 coupled to a rear portion of the cellular phone 10, the light-emitting object 65 emits light when the cellular phone 10 is online or the NFC module is activated, and the emitted light allows a user or operator to recognize that the cellular phone 10 is online. In addition, since the light-emitting object 65 expresses a business name or a logo of a cellular phone manufacturer or a common carrier when the cellular phone 10 is online, promotion of said business, cellular phone manufacturer or common carrier may be maximized.

Moreover, the light-emitting device 30 according to the present invention uses the light-emitting diode 50 having low power consumption and efficiently utilizes total reflection to propagate the light coming from the light-emitting diode 50, such that light is emitted to the outside of the battery cover 25 through the light-emitting object 65, and thus users may recognize clear visual effects.

Even if a separate power source is not connected to the battery cover 25, the light-emitting diode 50 emits light by using electromagnetic waves emitted when the cellular phone 10 is online or reception of a call requesting signal in the cellular phone 10, such that the light-emitting object 65 emits light and the emitted light may be seen from the outside through the display 35.

As such, the cellular phone according to the present invention drives the light-emitting device installed in the battery cover by using the electromagnetic waves emitted from the cellular phone when the cellular phone 10 is online as a power source, and thus, even without a separate power supply to the battery cover which is separated from the main body of the cellular phone, the light-emitting device operates using the electromagnetic waves emitted from the cellular phone during phone communication. Therefore, the aesthetic function of the cellular phone or visibility in mobile payment may be improved without consuming additional power from the battery in order to operate the light-emitting device.

While the present invention has been described with exemplary embodiments thereof, the present invention is not limited by the embodiments and embodiments in various forms may be made without departing from the technical spirit of the present invention.

### MODE OF THE INVENTION

A cellular phone having a light-emitting device in a battery cover of the cellular phone according to an exemplary embodiment of the present invention includes a main body that forms an outer form of the cellular phone and that includes a battery-receiving portion for installing a battery in a rear portion of the main body, a battery cover that covers the battery-receiving portion and is removably coupled to the main body, a power-generating antenna in the form of a coil that is provided in the battery cover and converts electromagnetic waves emitted from the cellular phone into electricity based on electromagnetic induction, a light-emitting diode that is electrically connected to the power-generating antenna to generate light, a light-transfer sheet that transfers the light generated in the light-emitting diode by using total reflection, and a light-emitting object that is formed on a surface of the light-transfer sheet and emits the light generated from the light-emitting diode to the outside of the battery cover through total reflection of the light.

The light-emitting object is formed on a surface of the light-transfer sheet by being printed in ink, and the light-emitting object may include a dot pattern, a line pattern, or a face pattern.

The light-transfer sheet may be made of one of poly acryl, poly carbonate (PC), poly ethylene (PET), a poly urethane (PU), a polymethacryl acid methyl ester (PMMA), a polyvinyl chloride (PVC), and silicon.

The light-emitting object is provided as a plurality of light-emitting objects that have different colors.

The light-emitting object may include one selected from a group of modified poly acryl, modified poly urethane (PU), modified polyester (PE), and silicon dioxide (SiO₂).

The light-emitting object may include a fluorescent material or a dispersing agent.

1. A cellular phone having a light-emitting device in a battery cover of the cellular phone, the cellular phone comprising:
a main body that forms an outer form of the cellular phone and that comprises a battery-receiving portion for installing a battery in a rear portion of the main body;
the battery cover, wherein the battery cover covers the battery-receiving portion and is removably coupled to the main body;
a power-generating antenna in a form of a coil that is provided in the battery cover and converts electromagnetic waves emitted from the cellular phone into electricity based on electromagnetic induction;
a light-emitting diode that is electrically connected to the power-generating antenna to generate light;
a light-transfer sheet that transfers the light generated in the light-emitting diode, by using total reflection; and
a light-emitting object that is formed on a surface of the light-transfer sheet and emits the light generated from the light-emitting diode to the outside of the battery cover by reflecting the light generated from the light-emitting diode,
wherein the cellular phone has a mobile commerce function, and the power-generating antenna converts electromagnetic waves exchanged during communication with a mobile commerce terminal into electricity based on electromagnetic induction.

2. The cellular phone of claim 1, wherein the light-emitting object is formed on the surface of the light-transfer sheet by being printed in ink, and the light-emitting object comprises a dot pattern, a line pattern, or a face pattern.

3. The cellular phone of claim 1, wherein the light-transfer sheet is made of one of poly acryl, poly carbonate (PC), poly ethylene (PET), a poly urethane (PU), a polymethacryl acid methyl ester (PMMA), a polyvinyl chloride (PVC), and silicon.

4. The cellular phone of claim 1, wherein the light-emitting object is provided as a plurality of light-emitting objects that have different colors.

5. The cellular phone of claim 1, wherein the light-emitting object comprises one selected from a group of modified poly acryl, modified poly urethane (PU), modified polyester (PE), and silicon dioxide (SiO₂).

6. The cellular phone of claim 1, wherein the light-emitting object comprises a fluorescent material or a dispersing agent.
